(19) United States
(12) Patent Application Publication
(10) Pub. No.: US 2011/0281991 A1
(43) Pub. Date: Nov. 17, 2011

(54) CORE-SHELL METAL NANOPARTICLES AND METHOD FOR MANUFACTURING THE SAME

(75) Inventors: Chih-Wei CHOU, Taichung (TW); Chih-Hsiu Chen, Taichung (TW); Wen-Hsin Lin, Taichung (TW); Hong-Ru Lin, Taichung (TW); Te-Hsing Wu, Taichung (TW); Yang-Chia Shih, Taichung (TW)

(73) Assignee: CHINA MEDICAL UNIVERSITY, Taichung (TW)

(21) Appl. No.: 12/977,603

(22) Filed: Dec. 23, 2010

(30) Foreign Application Priority Data
May 11, 2010 (TW) 099114924

(51) Int. Cl. C08L 5/00; C08K 3/08; C08F 2/48; B05D 7/14; C08F 2/46

(52) U.S. Cl. 524/440; 427/213.33; 427/487; 427/512; 524/612

(57) ABSTRACT

A method for manufacturing core-shell metal nanoparticles is provided. The method comprises providing a first solution containing a metal ion; providing a second solution containing Arabinogalactan and having a pH value ranging from about 1 to about 13; mixing the first solution and the second solution to form a third solution; and enabling the third solution to perform an oxidation-reduction reaction to form the core-shell metal nanoparticles. The core-shell metal nanoparticles comprise a core composed of metal; and a shell, composed of Arabinogalactan, covering the surface of he core.

This application claims priority to Taiwan Patent Application No. 099114924 filed on May 11, 2010, the disclosures of which are incorporated herein by reference in their entirety.

### FIELD

The present invention relates to core-shell metal nanoparticles and a method for manufacturing the same. In particular, the present invention relates to core-shell metal nanoparticles comprising a metal core with Arabinogalactan covering the surface of the metal core, and a method for manufacturing the same.

### BACKGROUND

Nanoparticles have special electrical, chemical, physical and optical properties because of its surface effects, quantum size effects and quantum tunneling. When the particle size is nanoscaled, the ratio of the surface atoms to the bulk atoms increases significantly, resulting in nanoaparticles with generally lower melting point and sintering point as well as higher catalytic and chemical activities. For example, comparing the nanoparticles and non-nanoparticles of transition metals, the magnetic, catalytic and optical properties of the former are better than those of the latter. Thus, the nanoparticles of transition metals are widely used in various fields, such as optoclectronic elements, catalysts, medical industries, etc. For example, the catalysis of gold nanopartices is described in “Using gold nanoparticles for catalysis”, Nanotoday; August 2007, Volume 2, Number 4 by David T. Thompson. In addition, the applications of gold nanoparticles in medical industry is described in “Photothermal Nanotherapeutics and Nanodiagnostics for Selective Killing of Bacteria Targeted with Gold Nanoparticles”, Biophysical Journal, Volume 90, January 2006, 619-627 by Vladimir P. Zharov et al. and in “Increased apoptotic potential and dose-enhancing effect of gold nanoparticles in combination with single-dose clinical electron beams on tumor-bearing mice”, Cancer Sci, July 2008, Vol. 99, No. 7, 1479-1484 by Meng-Ya Chang et al

Currently, several methods for preparing metal nanoparticles have been provided such as oxidation-reduction, photochemical, electrochemical, gas evaporation, laser peeling, etc. For example, according to the oxidation-reduction method, metal ions are reduced to form metal nanoparticles by using chemical reducing agents (such as sodium borohydride, sodium citrate, etc.) during the preparation process. However, there are many disadvantages in conventional methods such as difficulty in controlling particle sizes, poor dispersion, short storage-life, etc. Especially, the chemical reducing agent or protecting agent (such as the cationic surfactant like cetyltrimethylammonium bromide (CTAB) used in the oxidation-reduction method) would generate environment-unfriendly and bio-hazardous substances like quaternary ammonium salts.

In view of the above, the inventors have developed a novel method for preparing metal nanoparticles, wherein the core-shell metal nanoparticles are prepared in one single step without using the environment-unfriendly chemical reducing agent, and have excellent dispersion and storage-life.

### SUMMARY

One objective of the present invention is to provide a method for manufacturing core-shell metal nanoparticles, comprising:
providing a first solution containing a metal ion;
providing a second solution containing Arabinogalactan and having a pH ranging from about 1 to about 13;
mixing the first and second solution to form a third solution; and
enabling the third solution to perform an oxidation-reduction reaction to form the core-shell metal nanoparticles.

Another objective of the present invention is to provide core-shell metal nanoparticles manufactured by said method, comprising:
a core composed of metal; and
a shell composed of Arabinogalactan, covering the surface of the core.

The aforesaid objective, the technology features and the advantages of the present invention are further described in the following paragraphs with specific embodiments and drawings appended.

### BRIEF DESCRIPTION OF THE DRAWINGS

FIG. 1 shows an X-ray analysis result of an embodiment of the core-shell gold nanoparticles according to the present invention;

FIG. 2 shows a TEM picture of an embodiment of the core-shell gold nanoparticles according to the present invention;

FIG. 3 shows a TEM picture of anther embodiment of the core-shell gold nanoparticles according to the present invention;

FIG. 4 is a comparison chart of the absorbance spectrums of the core-shell gold nanoparticles according to the present invention;

FIG. 5 shows an UV absorption spectrum of the core-shell gold nanoparticles according to the present invention;

FIG. 6 shows an absorption spectrum of the core-shell silver nanoparticles according to the present invention; and

FIG. 7 shows an absorption spectrum of the core-shell gold nanoparticles according to the present invention prepared by using dimethyl sulfoxide as a solvent.

### DESCRIPTION

The following will concretely describe some embodiments according to the present invention along with the drawings appended. However, the present invention may be embodied in other embodiments without departing from the spirit of the present invention. The scope of protection of the present invention should not be limited to the embodiments described in the specification. In addition, for clarity, the size of each element and each area may be exaggerated in the drawings and is not depicted to their actual scale.

Arabinogalactan is a natural polysaccharide composed of arabinose and galactose, which has good biocompatibility and is generally used in heath foods. By continuing research, the inventors found that an environment-friendly method for preparing the metal nanoparticles can be provided by replacing the conventional chemical reducing agent with said natural polysaccharide, and the metal nanoparticles are provided with wider applicability in view of their core-shell structures and high biocompatibilities.

The method according to the present invention comprises providing a first solution containing a metal ion; providing a second solution containing Arabinogalactan and having a pH value ranging from about 1 to about 13; mixing the first solution and the second solution to form a third solution; and enabling the third solution to perform an oxidation-reduction reaction to form the core-shell metal particles. Any desired metal ions can be used depending on needs and there is no particular limitation thereon. The metal ion, for example, is a transition metal ion selected from a group consisting of a gold ion, a silver ion, a palladium ion, a platinum ion, a rhodium ion, a ruthenium ion, an osmium an iridium ion and combinations thereof. In some embodiments of the present invention, a gold ion, a silver ion or a combination thereof is adopted.

In the method according to the present invention, a proper amount of a metal compound is dissolved in a first solvent to provide a first solution containing an ion of the metal; and a proper amount of Arabinogalactan is dissolved in a second solvent to provide a second solution. The metal compound, for example, may be metal salts or metal complexes which can provide the desired metal ion. If necessary, more than one metal compound may be adopted simultaneously to prepare core-shell metal nanoparticles in which the metal core is in an alloy form. In some embodiments of the present invention, hydrogen tetrachloroaurate, silver nitrate or a combination thereof is adopted. The first solvent and the second solvent may be any appropriate solvent that can dissolve the metal ion and Arabinogalactan. For example, the first solvent and the second solvent may be polar solvents independently. In some embodiments of the present invention, dimethyl sulfoxide or water is adopted.

Without being restricted by any theories, it is believed that the metal core of the core-shell metal nanoparticles is provided by reducing the metal ion in the first solution; and the shell covering the surface of the core is provided by Arabinogalactan in the second solution according to method of the present invention. If the concentrations of the metal ion and the

Arabinogalactan in the solution are too low, nanometals with desired particle size and in a core-shell form cannot be provided and the productivity is poor. On the contrary, if the concentrations are too high, the desired core-sell particles cannot be generated due to metal aggregation, and the cost is too high. Thus, to achieve the best production efficiency, according to the method of present invention, the metal ion concentration should be more than about 0.1 mM, preferably from about 0.5 mM to about 20 mM, while the concentration of Arabinogalactan in the second solution should range from about 2.5×10⁻²mM to about 15 mM, preferably from about 2.5×10⁻¹ mM to about 4.5 mM. It is found that when the first solution and the second solution are mixed in amounts so that the molar ratio of the metal ion to Arabinogalactan ranges from about 6.7×10⁻³ to about 800, preferably from about 5×10⁻² to about 100, the productivity of core-shell metal nanoparticles is better and the distribution of the particle size is more uniform. Under the above the suitable molar ratio range, the particle size of core-shell metal nanoparticles can be adjusted via adjusting the mixing proportion of the metal ion and Arabinogalactan depending on needs.

In the method according to the present invention, after mixing the first solution and the second solution to form the third solution, energy is provided to the third solution for enabling the third solution to perform an oxidation-reduction reaction to form the desired core-shell metal nanoparticles. The energy may be provided in the form of thermal energy, radiation energy or a combination thereof. For example, energy may be provided by heating (through a water bath, an oil bath, an electric heater etc.) or irradiating (through ultraviolet radiation, y-ray radiation etc.) the third solution. In the heating method, the heating temperature employed generally ranges from about 30° C. to about 150° C., preferably from about 40° C. to about 95° C. The heating duration time ranges from about 5 mins to about 180 mins. If the heating temperature is too low, the oxidation-reduction reaction will not be performed effectively and thus, result in poor productivity. On the contrary, if the heating temperature is too high, the structure of Arabinogalactan can be damaged easily. In the radiating method, the third solution is irradiated with ultraviolet having a power ranging from about 5 W to about 1000 W. The radiating duration ranges from about 1 min to 60 mins to enable the third solution to perform the oxidation-reduction reaction. Similarly, if the irradiating power is too low, the oxidation-reduction reaction will not be performed effectively and result in poor productivity; and on the contrary, if the radiating power is too high, the structure of Arabinogalactan can be damaged easily.

The method according to the present invention is free of adding environment-unfriendly chemical reducing agents during the preparation of core-shell metal nanoparticles, and only one single step is required to prepare the core-shell metal nanoparticles with excellent dispersion and biocompatibility.

The present invention further provides core-shell metal nanoparticles prepared by the above method, which comprises a core composed of metal; and a shell, composed of Arabinogalactan, covering the surface of the core. The shell composed of Arabinogalactan can prevent the metal nanoparticles from aggregating with each other and result in better dispersibility in the solution. In addition, since the functional groups of Arabinogalactan can bond with an antibody or a protein, the core-shell metal nanoparticles according to the present invention are very suitable for medical testing use, biomedical material use or the like, such as anti-cancer therapy, glucose testing, or a drug carrier for delivering the medicine to the target organ.

There is no particular limitation on the metal material composing the core of the core-shell metal nanoparticles according to the present invention, and any suitable materials (e.g., a transition metal) may be selected depending on needs. For example, the metal may be selected from a group consisting of gold, silver, palladium, platinum, rhodium, ruthenium, osmium, iridium and alloys thereof. In some embodiments of the present invention, gold, silver or a combination thereof is adopted.

Hereinafter, examples will be described to further illustrate the present invention.

### EXAMPLES 1

### Preparing Core-Shell Gold Nanoparticles by Means of Heating

All the sample bottles and vessels needed were firstly cleaned with aqua regia, and then washed with ultra-pure water and dried.

One gram of Arabinogalactan powder was weighed and well-stirred with ultra-pure water in a sample bottle until completely dissolved; and the pH value of the solution was adjusted by using hydrochloric acid and sodium hydroxide to provide an Arabinogalactan aqueous solution with a total volume of 20 ml and a concentration of 2.5 mM.

The Arabinogalactan solution was mixed with a pre-prepared hydrogen tetrachloroaurate (HAuCl₄) aqueous solution (10 mM) in such an amount that the molar ratio of gold ions to Arabinogalactan was about 4. The resultant mixed solution was heated with water bath at 95° C. for 1 hour and a dispersion of core-shell gold nanoparticles was then prepared.

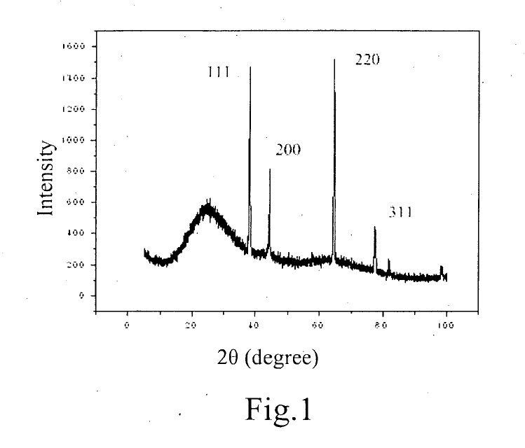

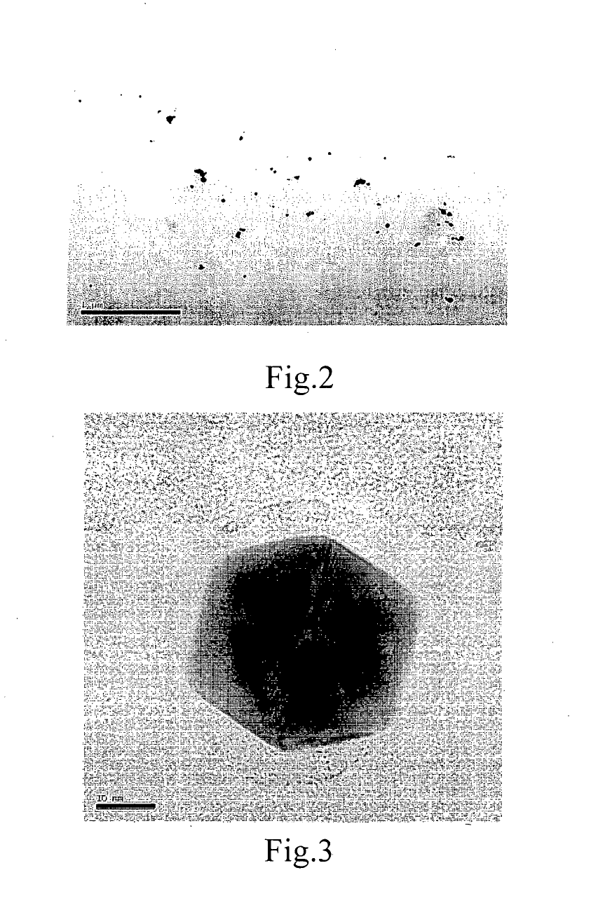

The resultant dispersion was examined by X-ray analyzer and observed by Transmission electron microscopy (TEM). FIG. 1 shows the X-ray analysis results. From the characteristic peaks at 38.2°, 44.3°, 64.5° and 77.6°, it can be known that the core-shell gold nanoparticles prepared by the present invention have a face-centered cubic structure. FIG. 2 shows the TEM analysis results and it shows that the core-shell gold nanoparticles distributed very uniformly in the solution.

### EXAMPLE 2

The structure of Core-Shell Gold Nanoparticles

The dispersion of core-shell gold nanoparticles was prepared in the same manner as Example 1 except that the hydrogen tetrachloroaurate aqueous solution and the Arabinogalactan solution was mixed in such an amount that the molar ratio of gold ions to Arabinogalactan was about 4.

The resultant dispersion was observed by TEM and the result is shown in FIG. 3. The core-shell gold nanoparticles can be observed clearly from FIG. 3, wherein the outer portion with the lighter color and composed of Arabinogalactan surrounds the surface of the gold particle (the darker portion in the middle), and the size of the core-shell gold nanoparticles is about 38 nm.

### EXAMPLE 3

The effect of the Mixing Ratio of Gold Ions to Arabinogalactan

Dispersions a, b, c, d and e of core-shell gold nanoparticles were prepared in the same manner as Example 1 except that the molar ratios of gold ions to Arabinogalactan were respectively about 0.4, 1, 2, 3 and 4.

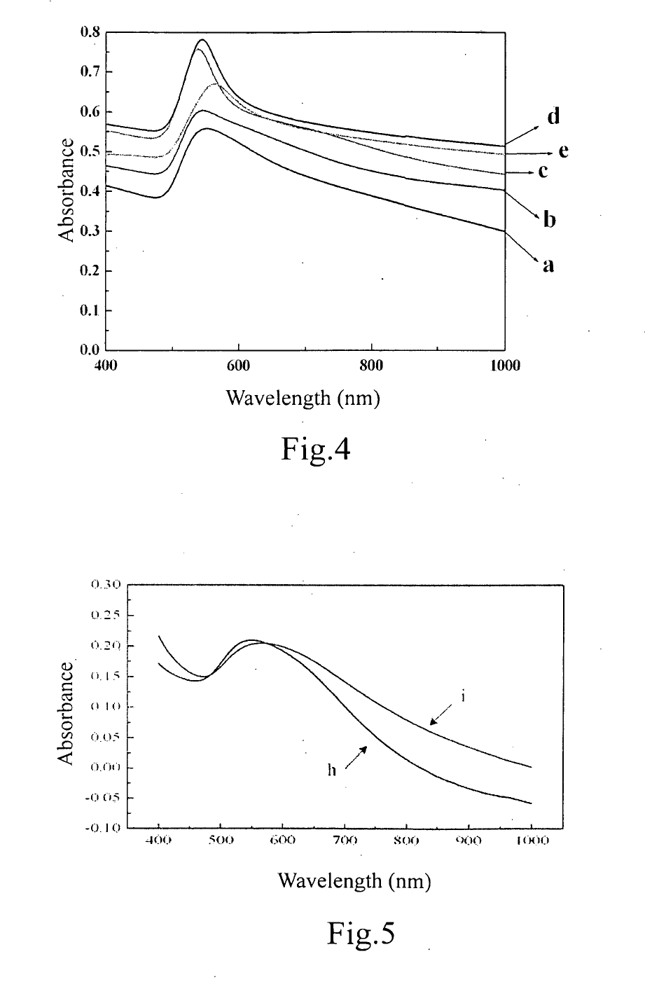

The absorbance values were obtained by examining the resultant dispersions with UV-VIS spectrometry and the results are shown in FIG. 4. As shown in FIG. 4, among the absorption spectrums of the dispersions a, b, c, d and e (the position of the maximum absorbance peak is about 530 nm), the absorbance values are varied with the variation of the mixing ratio of gold ions to Arabinogalactan. The productivity of the core-shell gold nanoparticles may be enhanced by varying the mixing ratio of gold ions to Arabinogalactan. In addition, the widths and positions of the absorbance peaks are also varied with the mixing ratio of gold ions to Arabinogalactan. By changing the mixing ratio of gold ions to Arabinogalactan, the uniformity of the core-shell gold nanoparticles can be enhanced (the sharper the peaks, the more uniform the particle size) and the particle size of the core-shell gold nanoparticles can be changed (the more the peaks shift towards the long wavelength direction, the larger the particle size).

### EXAMPLE 4

### Preparing the Core-Shell Gold Nanoparticles by Ultraviolet Irradiation

The dispersions of the core-shell gold nanoparticles were prepared in the same manner as Example 1 except that an ultraviolet with a power of 1000W was used to irradiate the mixed solution for about 6 mins to provide the energy required for performing the oxidation-reduction reaction, wherein the mixing ratio of gold ions and Arabinogalactan are respectively about 0.17 and about 1 for preparing dispersions h and i of the core-shell gold nanoparticles.

The absorbance values of the dispersions were examined by using UV-VIS spectrometry and the results are shown in FIG. 5. As shown in FIG. 5, both dispersions h and i have obvious absorbance peaks of core-shell gold nanoparticles at about 530 nm.

### EXAMPLE 5

### Preparing the Core-Shell Silver Nanoparticles by Heating

The dispersions containing core-shell silver nanoparticles were prepared in the same manner as Example 1 except that the hydrogen tetrachloroaurate solution was substituted with a pre-prepared silver nitrate aqueous solution (about 5 mM), wherein the molar ratios of silver ions to Arabinogalactan were respectively about 2, 3, 13 and 20 for preparing dispersions j, k, l and m containing core-shell silver nanoparticles.

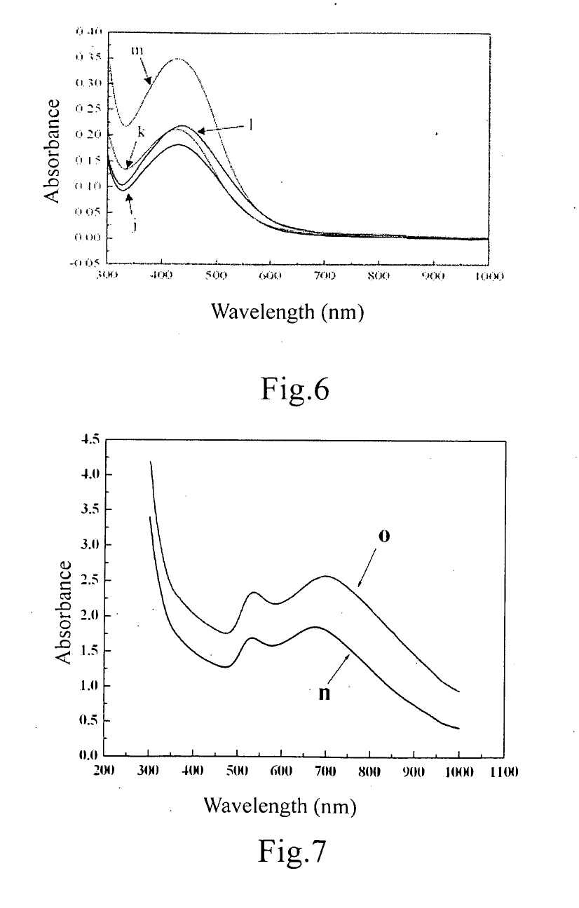

The absorbance values were obtained by examining the resultant dispersions with UV-VIS spectrometry and the results are shown in FIG. 6. As shown in FIG. 6, the dispersions j, k, l and m have obvious absorbance peaks of core-shell silver nanoparticles at about 430 nm.

### EXAMPLE 6

### Preparing the Core-Shell Gold Nanoparticles by Using Dimethyl Sulfoxide as a Solvent

Dispersions containing core-shell gold nanoparticles were prepared in the same manner as Example 1 except that dimethyl sulfoxide rather than water was adopted as the solvents of the Arabinogalactan solution and the hydrogen tetrachloroaurate solution, wherein the mixing ratio of gold ions and Arabinogalactan are respectively about 2 and about 3 for preparing dispersions n and o of core-shell gold nanoparticles.

The absorbance values were obtained by examining the resultant dispersions with UV-VIS spectrometry and the results are shown in FIG. 7. As shown in FIG. 7, both dispersions n and o have obvious absorbance peaks of core-shell gold nanoparticles at about 530 nm.

Given the above, by replacing the conventional chemical reducing agent with natural polysaccharide (Arabinogalactan), the present invention can provide core-shell metal nanoparticles with high biocompatibility and environment-friendly means. In addition, the particle size of the resultant core-shell metal nanoparticles can be adjusted by varying the mixing ratio during the preparation.

The said examples are used to exemplify the theorem and effects of the present invention, and to elaborate the features of the present invention, which has no means for limiting the scope of the present invention. Any alterations and arrangements, which may be accomplished by a person skilled in the art without departing from the principle and spirit, also belong in the scope stated by the present invention. According, the scope of the present invention is cited as in the claims.

What is claimed is:

1. A method for manufacturing core-shell nanoparticles, comprising:
providing a first solution containing a metal ion;
providing a second solution containing Arabinogalactan and having a pH value ranging from about 1 to about 13;
mixing the first solution and the second solution to form a third solution; and
enabling the third solution to perform an oxidation-reduction reaction to form the core-shell metal nanoparticles.

2. The method of claim 1, wherein the metal ion is a transition metal ion.

3. The method of claim 2, wherein the metal ion is selected from a group consisting of a gold ion, a silver ion, a palladium ion, a platinum ion, a rhodium ion, a ruthenium ion, an osmium ion, an iridium ion, and combinations thereof.

4. The method of claim 3, wherein the metal ion is a gold ion, a silver ion or a combination thereof.

5. The method of claim 1, wherein the step of providing the first solution comprises dissolving a metal compound containing the metal ion into a first solvent, and the step of providing the second solution comprises dissolving Arabinogalactan into a second solution, wherein the first solvent and the second solvent are independently a polar solvent.

6. The method of claim 5, wherein the first solvent and the second solvent are independently selected from a group consisting of dimethyl sulfoxide and water.

7. The method of claim 1, wherein the first solution and the second solution are mixed in such an amount that the molar ratio of the metal ion to Arabinogalactan ranges from about 6.7×10⁻³ to about 800.

8. The method of claim 7, wherein the first solution and the second solution are mixed in such an amount that the molar ratio of the metal ion to Arabinogalactan ranges from about 5×10⁻² to about 100.

9. The method of claim 1, wherein the step of enabling the third solution to perform the oxidation-reduction reaction comprises subjecting the third solution to at least one of heating and irradiating.

10. The method of claim 9, wherein the step of enabling the third solution to perform the oxidation-reduction reaction comprises heating the third solution at a temperature ranging from about 30° C. to about 150° C.

11. The method of claim 10, wherein the third solution is heated at a temperature ranging from about 40° C. to about 95° C.

12. The method of claim 9, wherein the step of enabling the third solution to perform the oxidation-reduction reaction comprises irradiating the third solution with ultraviolet having a power ranging from about 5W to about 1000W.

13. A core-shell metal nanoparticle, comprising:
a core composed of metal; and
a shell, composed of Arabinogalactan, covering on the surface of the core.

14. The core-shell metal nanoparticle of claim 13, wherein the metal is transition metal.

15. The core-shell metal nanoparticle of claim 14, wherein the metal s select from a group consisting of gold, silver, palladium, platinum, rhodium, ruthenium, osmium, iridium and alloys thereof.

16. The core-shell metal nanoparticle of claim 15, wherein the metal is gold, silver or an alloy of gold and silver.
